(19) United States
(12) Patent Application Publication
(10) Pub. No.: US 2010/0089816 A1
(43) Pub. Date: Apr. 15, 2010

(54) LIQUID FILTER APPARATUS

(75) Inventors: Brian Pahl, Louisville, KY (US); David Reed, Louisville, KY (US)

Correspondence Address: Mann+Hummel GMBH;Department VR-P, Hindenburgstr. 45, Ludwigsburg, 71638, DE

(73) Assignee: MANN+HUMMEL GMBH, Ludwigsburg (DE)

(21) Appl. No.: 12/248,084

(22) Filed: Oct. 9, 2008

(51) Int. Cl. B01D 29/09

(52) U.S. Cl. 210/386; 210/400

(57) ABSTRACT

A filter apparatus for filtering material solids from a liquid having a filter belt driven by a pair of belt transport chains and including a purged seal member to limit bypass of unfiltered fluid around the filter belt. The filter apparatus includes a plurality of flight bars configured to float above the filter belt thereby reducing wear. Also included is a webbing layer provided on filter belt outboard portions including holes with grommets configured to engage with the belt transport chains.

### TECHNICAL FIELD

The present invention relates to belt filtering apparatus, particularly for filtering liquids to remove larger chips and entrained solids.

### BACKGROUND OF THE INVENTION

The present invention relates to a belt filter apparatus for filtering material solids from a liquid stream. One particularly useful application is in filtering larger material solids such as cutting chips from the cutting tool coolant/lubricant in milling and machining environments as well as aggregating and conveying the material solids for collection.

Published U.S. Patent Application 2007/0051672 discloses a filter apparatus for filtering coolant/lubricant from a machining operation, particularly for filtering cutting chips that have a density that is less than the density of the cutting fluid and therefore may tend to float on the surface of the cutting fluid.

U.S. Pat. No. 4,963,836 discloses a filter apparatus having a filter tank and moving belt filter element for filtering chips from contaminated liquids from industrial operations.

Published European Patent Application EP1053825 discloses a chip treatment device having a box shaped housing and moving scraper units configured to remove machining chips from a partition unit and transport the chips away from the liquid bath.

U.S. Pat. No. 4,693,836 discloses a liquid filtration apparatus having a filter tank, filtration media and a bypass prevention apparatus.

### SUMMARY OF THE INVENTION

The present invention provides belt filtration apparatus configured for removing solid materials from liquid streams and having a number of improvements over the prior art. The filtration apparatus includes a filter tank having an inlet for admitting unfiltered liquid, a filter tank, an outlet chamber sealably secured to the tank and an outlet for delivering filtered liquid. The filtration apparatus includes a filter belt system with a continuous loop filter belt having a filter media embedded in the belt. A perforated support member is secured to a bottom wall of the filter tank and supportively contacts the clean side of the filter belt. The filtration apparatus includes at least one pair of fluid seal members with each positioned proximate to and having a first portion extending over the outboard portions of the filter belt. The fluid seal members are secured to the sidewalls of the filter tank. Each fluid seal member includes a closure member extending outwards from the fluid seal member into a position proximate to the filter belt, in certain embodiments the closure member is “T” shaped. The closure member is operable to limit filter belt bypass flow through the seal member. Additionally, the seal members include a pressurized fluid purge whereby the perforated support member together with the filter belt, the fluid seal members and the pressurized fluid purge are configured to maintain separation of the unfiltered liquid in the filter tank and the filtered liquid in the outlet chamber.

In another aspect of the invention, the filter apparatus includes a flight chain assembly. The flight chain assembly includes a pair of flight chains, each forming a continuous loop along a flight chain path and positioned in a spaced parallel relationship. Also included is a plurality of flight bars extending between and secured at opposing ends to the pair of flight chains and positioned in a spaced relationship along the flight chains. The flight bars are arranged substantially perpendicular to the flight chain path and perpendicular to the movement of the filter belt. The movement of the flight bars acts together with the movement of the filter belt to transport the material solids separated from the filtered liquid to the discharge opening. A plurality of pairs of flight chain sprockets are positioned about a flight chain path to guide, support and tension the flight chain, wherein at least one of the flight chain sprocket pairs is operable to driveably move the flight chain along the flight chain path. The flight chains support the flight bars in a position proximate to but not contacting the filter belt.

In another aspect of the invention, the flight chains include roller wheels rollably secured to chain segments and having a wheel diameter selected to rollably support the flight chains on the dirty side of the filter belt.

In another aspect of the invention, the filter belt includes a webbing layer secured to the filter belt at the outboard portion of the filter belt. The filter belt also is provided with a plurality of attachment holes extending through the webbing layer and the filter belt. Grommets are secured to the filter belt at the holes to strengthen the filter belt around the holes.

In another aspect of the invention, the belt transport chains further include a plurality of threaded protrusions adapted to insert into the grommets for removably securing the filter belt to the belt transport chains.

In another aspect of the invention, the belt transport chains further include a plurality of studs adapted to insert into the grommets; the filter belt and grommets are removably secured to the studs and transport chains by cotter pins.

In another aspect of the invention the flight chains further comprise oversize rollers rotatably secured to segments of the flight chain, the oversize rollers configured to rollably ride upon the webbing and to space apart the flight bars from the filter belt. The roller wheels are provided with a diameter larger than a segment width of the flight chains.

In another aspect of the invention, the inlet for liquid to be filtered is connected to a source of dirty coolant/lubricant liquid from a machining operation.

In another aspect of the invention, the filter apparatus includes a vacuum pump in fluid communication with the outline line. The vacuum pump is operable to increase a pressure differential across the filter belt so as to increase liquid flow rate therethrough. The vacuum pump is configured to shutdown during periods when the filter belt is indexing and a clean tank is operably connected to an outlet of the pump. The clean tank is operable to subsidize fluid flow rate from the filter apparatus during periods when the filter belt is indexing. The clean tank is elevated to provide sufficient head pressure to supply the pressurized fluid purge to the seal members.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic view of a filtration system including a preconveyor filter and a vacuum filter connected in serial fashion;

FIG. 2 is a schematic sectional side view of one embodiment of a filter apparatus illustrating interior components of the filter tank, consistent with the present invention;

FIG. 3A is a sectional view illustrating a portion of the filter belt, belt transport chains, flight chains, flight bars and the fluid seal members in the region of the perforated support member of filter tank, consistent with the present invention; and

FIG. 3B is an enlarged view of one of the fluid seal members at the outboard portion of the filter belt, consistent with the present invention; and

FIGS. 4A and 4B present top and side views of a portion of a flight chain having oversize roller wheels, consistent with the present invention.

### DESCRIPTION OF THE PREFERRED EMBODIMENTS

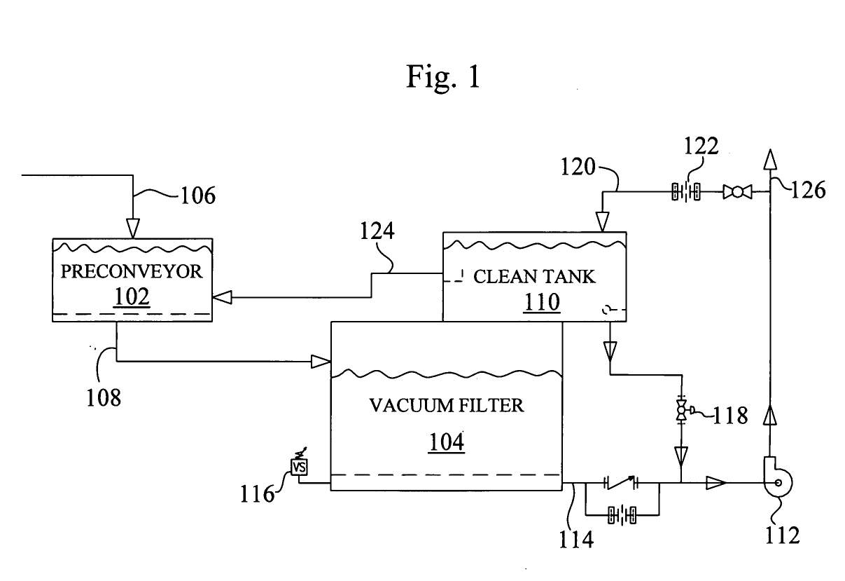

FIG. 1 is a schematic view of a filtration system 100 including two filter apparatus: a preconveyor filter 102 and a vacuum filter 104, connected in serial fashion. A fluid stream laden with material solids, such as from metal grinding or milling equipment enters the preconveyor filter 102 through a raw liquid feed line 106. Preconveyor filter 106 is a continuous loop belt filter apparatus with a belt filter media configured to remove the major portion of the material solids from the raw feed 106. Prefiltered liquid is discharged from the filtered outlet of preconveyor filter 102 and flows to the inlet of vacuum filter 104 through prefiltered liquid line 108. Vacuum filter 104 is a continuous loop belt filter apparatus having a filter belt filtration media configured to remove additional, mainly finer material solids from the prefiltered liquid line 108 that have made it through the filtration media of the preconveyor filter 102. For our purposes herein, the preconveyor filter 102 and vacuum filter 104 are both examples of filter belt filtration apparatus having continuous loop filter belt filtration media. Although the preconveyor filter 102 and vacuum filter 104 differ in many operational and structural respects, the present invention (as will be discussed in detail below) is advantageously applicable to either or both filter apparatus 102 and 104 as well as to other types of filter belt filtration systems.

Vacuum filter 104 includes an elevated clean tank 110 and one or more vacuum pumps 112. Vacuum pumps 112 operate to pull a partial vacuum on the outlet line 114 of the vacuum filter 104. A vacuum transducer 116 senses the vacuum pressure at the outlet chamber of the vacuum filter 104, and when the vacuum reaches a predetermined limit, the vacuum release valve 118 is automatically opened to supply filtered liquid from the clean tank 110 to the suction side of the vacuum pumps 112, thereby releasing the vacuum on the outlet chamber of vacuum filter 104 so that the filter belt of the vacuum filter 104 may more easily move or index. During operation of the vacuum filter 104, the clean tank 110 is continuously replenished with filtered liquid delivered through the clean tank supply line 120. An orifice plate 122 or other flow restriction device is provided in the clean tank supply line 120 to limit the flow rate to a relatively small percentage of the liquid flow rate supplied by the vacuum pumps 112. As a non-limiting example, the orifice plate 122 has a bore typically sized to pass about 5 to 10 percent of the fluid supplied by the vacuum pumps. The filtered liquid level in the clean tank 110 is determined by the elevation of the clean tank overflow line 124 on the clean tank 110. This system provides a ready reservoir of filtered fluid without the need to utilize level transmitters or other controls to control the liquid level of the clean tank 110. The clean tank overflow line 124 delivers filtered liquid to the preconveyor filter 102, including for use as a filtered liquid source for the pressurized fluid purge to the seal members to prevent unfiltered liquid from bypassing the filter belt, as will be discussed in detail below.

Filtered liquid return line 126 supplies filtered liquid (liquid with the solid materials substantially removed) for reuse in the manufacturing or other processes (for example, as coolant in metal grinding and milling operations).

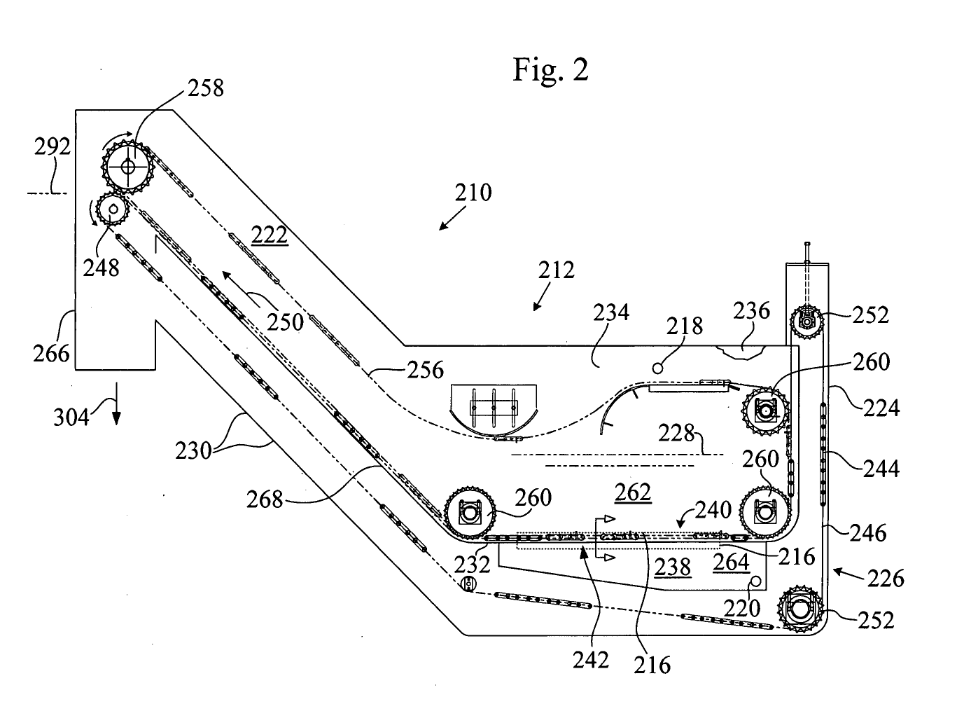

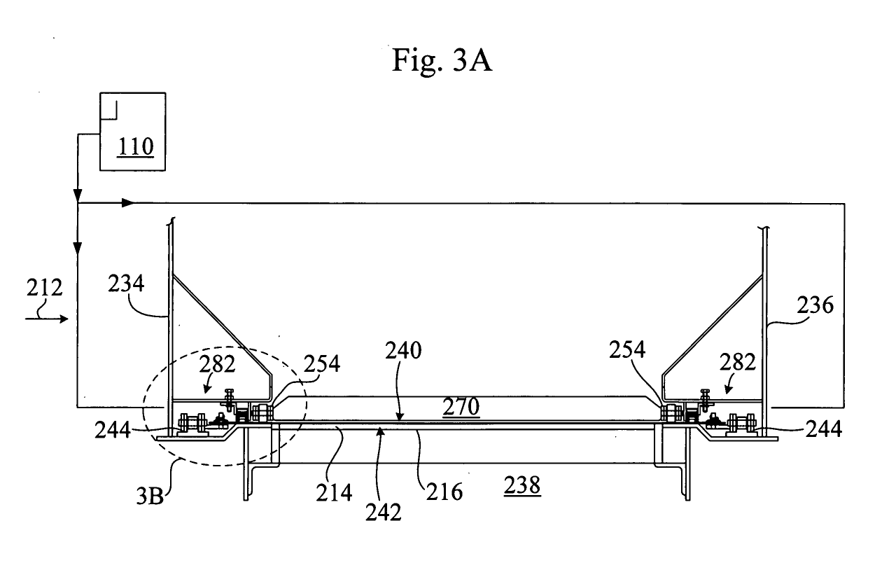

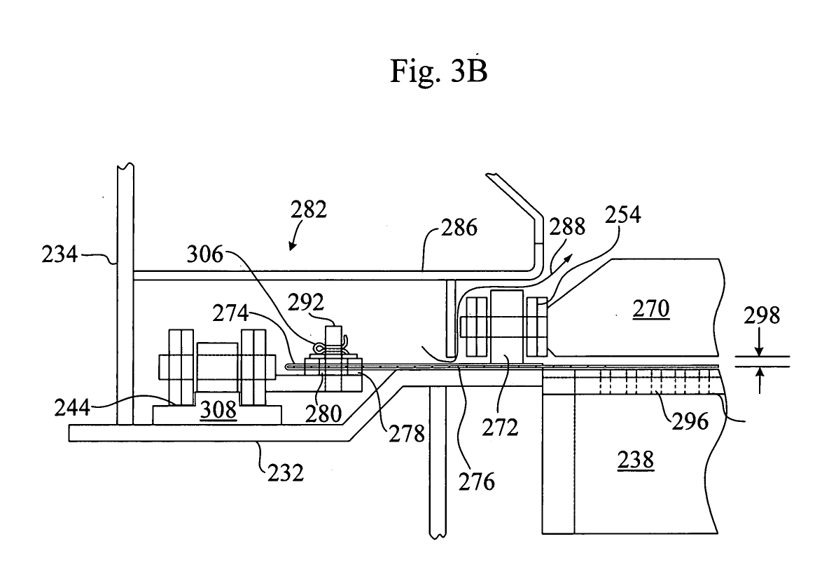

The discussion is now directed to FIGS. 2, 3A and 3B. FIG. 2 is a schematic sectional side view of one embodiment of the filter apparatus 210 (for example, preconveyor filter 102 of FIG. 1) illustrating interior components of the filter tank 212. FIG. 3A is a sectional view illustrating the filter belt 214, belt transport chains 244, flight chains 254, flight bars 270 and the fluid seal members 282 in the region of the perforated support member 216 of filter tank 212. FIG. 3B is an enlarged view of one of the fluid seal members 282.

Filter tank 212 includes a sloped discharge ramp portion 222 extending from a main portion of the filter tank 212 to a discharge elevation 292 positioned above the operating fluid level 228 of the filter tank 212. Sloped discharge ramp portion 222 includes a sloped discharge ramp bottom wall 230. Filter tank 212 further has a rear wall 224 opposing said sloped discharge ramp portion 222, and a tank bottom wall 232 with opposing sidewalls 234 and 236. Sidewall 234 includes an inlet line 218 configured to admit liquids or fluids to be filtered into the filter tank 212. Bottom wall 232 includes a perforated support member 216 (for one example, a perforated steel plate) having fluid permeable apertures extending therethrough and configured to permit filtered liquid to flow from the filter tank 212 into the outlet chamber 238. As illustrated in FIG. 2, outlet chamber 238 is a box-like structure positioned below the bottom wall 232 of the filter tank 212. Outlet chamber 238 is sealed to the bottom wall 232 such that liquid entering the outlet chamber 238 is confined to exit the outlet chamber 238 through the provided outlet line 220. During operation of the filter apparatus 210, unfiltered liquid enters the filter belt 214 at the dirty side 240 (see FIG. 3A), proceeds to migrate through filter pores in the filter belt 214 to then exit at the clean side 242 (see FIG. 3A) of the filter belt 214 as filtered liquid. The filtered liquid then passes through apertures 296 (see FIG. 3B) in the perforated support plate 216 to enter the outlet chamber 238. During operation of the filter apparatus 210, filtered solids removed from the filtered liquid accumulate on the dirty side 240 of the filter belt 214.

In some belt filter apparatus embodiments (for example, vacuum filter 104 in FIG. 1) the outlet line 220 may be in fluid communication with the suction side of a vacuum pump (or pumps) 112 operative to pull a partial vacuum within the outlet chamber 238, the partial vacuum thereby increasing a pressure differential between the dirty side 240 and clean side 242 of the filter belt 214 so as to improve the flow rate of liquid through the filter belt 214. In other embodiments which lack the vacuum pump 112 (for one example herein, preconveyor filter 102 in FIG. 1), the motive force to drive the flow of liquid through the filter belt 214 and perforated support plate 216 is provided by the gravity induced liquid head pressure of the unfiltered liquid 262 in the filter tank 212 as established by the height of the operating fluid level 228 above the dirty side 240 of the filter belt 214 (see FIG. 2).

Continuing with FIGS. 2, 3A and 3B, filtering apparatus 210 is equipped with a filter belt system 226 in which a filter belt 214 is configured as a closed loop of filter media. Also associated with the filter belt 214 is a pair of belt transport chains 244 positioned in a spaced parallel arrangement at opposing outboard portions 276 of the filter belts 214 and proximate to sidewalls 234, 236. The belt transport chains include a plurality of chain segments hingeably coupled so as to form the continuous loop belt transport chains 244. The belt transport chains 244 index about a path indicated by belt chain path 246. The filter belt 214 is secured to at least some of the segments of the belt transport chains 244 such that the chains are operative to drive the movement of the filter belt 214 around the belt chain path 246 with the belt transport chains 244 and filter belt 214 indexing as a unit.

A pair of axially aligned and spaced apart belt chain drive sprockets 248 engage the belt transport chains 244 so as to drive the movement of the filter belt 214. In FIG. 2, belt chain drive sprockets 248 rotate in a counter-clockwise direction to drive the filter belt 214 in a direction according to arrow 250 upwards on the sloped discharge ramp portion 222 of the filter tank 212. Additional pairs of belt chain sprockets 252 are positioned about the filter tank 212 so as to tension and guide belt transport chains 244 and the filter belt 214 along the belt chain path 246.

In some embodiments, a chain flight assembly is provided having a pair of flight chains 254 positioned in the filter tank 212 in a spaced parallel relationship. Each flight chain 254 is formed of a plurality of hingebly-linked segments coupled to form a continuous loop around the flight chain path 256. A pair of axially aligned and spaced apart flight chain drive sprockets 258 driveably engage the flight chains 254 so as to drive their movement around the flight chain path 256. In FIG. 2, axially spaced flight chain drive sprockets 258 rotate in a clockwise direction to drive the flight chains 254 according to direction arrow 250 upwards over discharge ramp wall 268 of the filter tank 212. Additional pairs of flight chain sprockets 260, each axially spaced apart to supportively engage flight chains 254 are positioned about the filter tank 212 to tension and guide the flight chains 254 along the flight chain path 256. Extending between and secured at opposing ends to the flight chains 254 are a plurality of a flight bars 270. The flight bars 270 are positioned in a spaced relationship along the flight chains 254 and are arranged substantially perpendicular to the flight chain path 256.

The belt chain drive sprockets 248 together with belt transport chains 244 drive the filter belt 214 in a counter-clockwise direction (according to the view presented in FIG. 2) such that the filter belt 214 indexes from the belt chain drive sprockets 248 downwards between the discharge ramp bottom wall 230 and discharge ramp wall 268 into an area under the outlet chamber 238, continuing upwards near the rear wall 224 of the filter tank 212, and then downwards towards the perforated support member 216 in the bottom wall 232 of the filter tank 212. Head pressure developed by the operating fluid level 228 of unfiltered liquid 262 in the filter tank 212 acts to maintain the filter belt 214 in sealed contact against the perforated support plate 216 ensuring the majority of unfiltered liquid 262 must first pass through and be filtered by the filter belt 214 before reaching the outlet chamber 238.

As unfiltered liquid 262 passes through the portion of the filter belt 214 positioned over the perforated support member 216, the relatively small size of the pores in the filter belt 214 blocks the passage of a major portion of the solid materials in the unfiltered liquid, these solid materials deposit onto the dirty side 240 of the filter belt 214. Initially, the deposition of solid material onto the filter belt 214 improves the removal of additional solid material from the unfiltered liquid 262 by providing additional obstruction and surface area onto which solids can adhere. As filtration continues, the deposition of substantial quantities of solid materials onto the dirty side 240 of the filter belt 214 eventually becomes too great and effects a reduction of flow of liquid through the filter belt 214 and into the outlet chamber 238. At this point it becomes necessary to index the filter belt 214 along the belt chain path to expose fresh portions of the filter belt with its filtration media. In certain embodiments the filter belt may be continuously driven so that it is continually exposing fresh filtration media onto the perforated support member 216. A continuously moving belt is useful in applications where the material solids quickly accumulate, such as in the preconveyor 102 (see FIG. 1) which is exposed directly to the prefiltered liquid stream 106 heavily laden with material solids. In other belt filter applications (such as vacuum filter 104) where filtered material solids accumulate on the filter belt at a slower rate, it is advantageous from an energy conservation and filter belt wear perspective to only intermittently index the filter belt 214. In operation, the flight bars 270 are configured to move together with the filter belt 214.

As the filter belt moves (or indexes) away from the perforated support member 216, the solid material laden portion of the filter belt 214 is removed from the region over the perforated support plate 216. The movement of the filter belt 214 carries the load of deposited solid materials upwards on the sloped discharge ramp portion 222 of the filter tank 212 and ultimately to the discharge chute 266 where the solid materials are released down the chute 266 as shown by arrow 304 (FIG. 2). Movement of the filter belt 214 exposes clean filter media over the perforated support member 216, thereby allowing the unfiltered liquid 262 to flow through the filter belt 214 and perforated support member 216 unimpeded by buildup of solid materials on the filter belt 214.

The perforated support member forms at least a portion of the bottom wall 232 over the outlet chamber 238. In the region where the filter belt 14 indexes over the perforated support member 216, across the bottom wall 232 and moves upwards on the discharge ramp wall 268 towards the discharge chute 266, the flight bars 270 are held in a closely spaced relationship to and advantageously floating above the filter belt 214 so as to engage against solid materials deposited on the filter belt and urge their transport towards the discharge chute 266. The flight bars 270 are secured to and driven by movement of the flight chains 254, which, as noted earlier, typically index or move together with the filter belt 214.

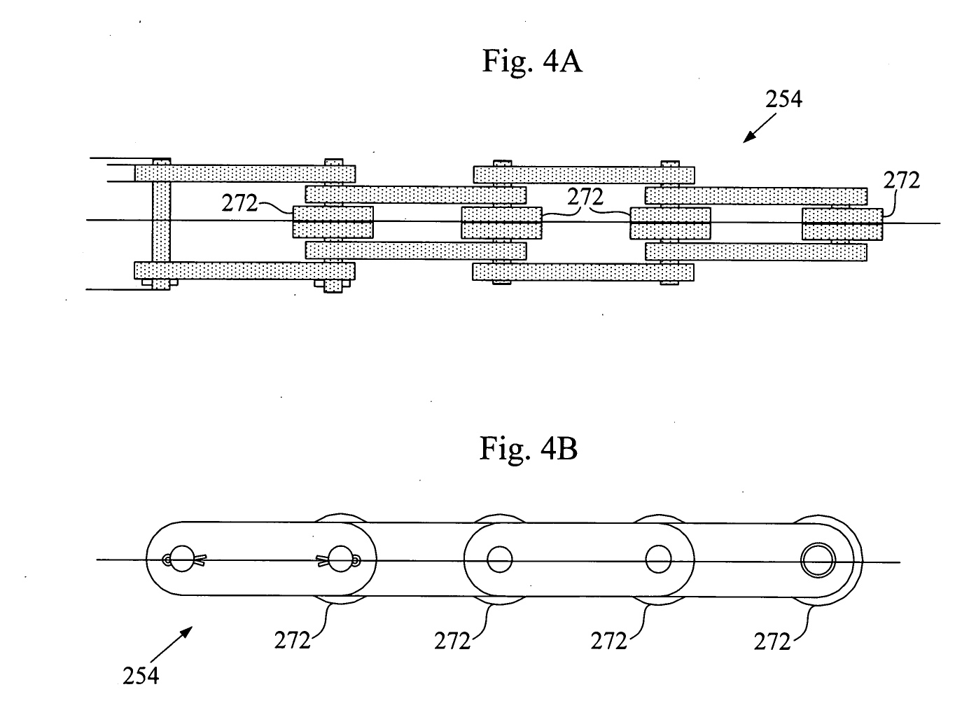

Advantageously, flight chains 254 are equipped with oversize roller wheels 272 (see FIGS. 4A and 4B), which roll upon the dirty side 240 of the filter belt 214, particularly at the outboard portions 276 of the filter belt 214. The geometry of the roller wheels 272, flight chains 254 and the mounting of the flight bars 270 to the flight chains 254 cooperate to fix the spacing in the closely spaced relationship between the flight bars 270 and filter belt 214 as discussed above. This can be particularly understood from FIGS. 3A and 3B. In a preferred embodiment this fixed spacing provides a gap 298 between the flight bars 270 and the filter belt 214 of approximately ⅛^{th} inch. This close spacing facilitates transport of material solids upwards on the sloped discharge ramp 222 while preventing direct contact between the flight bars 270 and the filter belt 214. Contact between the flight bars 270 and filter belt 214 is undesirable as this can result in additional wear and damage to the filter belt 214, shortening the service life of the filter belt 214.

Advantageously, the rolling support of the flight bars 270 above the filter belt 214 significantly reduces wear on the filter belt 214 as the flight bars no longer contact the filter belt. The flight chains as well are provisioned to roll rather than slide upon the filter belt 214 by the same roller wheels. In prior art belt filtration systems the flight bars typically engage against or slide on the filter belt resulting in increased wear and resulting in shortened filter belt service life.

Advantageously, the oversize roller wheels 272 on the flight chains 254 roll on the outboard portions 276 of the filter belt 214 in the region outboard of the perforated support member 216 (see FIGS. 3A, 3B), thereby advantageously not contributing to wear on the filtering portion (the portion of the filter belt 214 over the perforated member 216).

Advantageously, the significant reduction in filter belt wear in the present invention now permits the use of a thinner filter belt that would otherwise be feasible in the prior art. For one example, a previous design utilized a 1/16-inch thick filter belt with 500 um openings for liquid passage. Other prior art belt filteration systems utilize substantially thicker belts to resist wear due to cleats (discussed later) and their engagement with flight bars. With the reduction in belt wear of the present invention (due to floating flight bars and filter belts no longer drive by cleats), new filter belt designs are able to use a much thinner belt with only 100 um openings without sacrificing liquid filtering capacity and retaining low pressure drop characteristics. Advantageously, the smaller filter belt openings provide improved solid material removal/filtering performance by trapping smaller debris without compromising liquid filtering capacity.

Advantageously, in a preferred embodiment, service life and wear characteristics are further improved by the addition of webbing layers 274 sewn onto or otherwise secured onto the dirty side 240 of the filter belt 214. The webbing layer is positioned along the outboard portions 276 of the filter belt 214 and not in the filtering portion (interior portion) of the filter belt 214.

In at least one embodiment, the filter belt 214 is removably secured to the belt transport chains 244 by a plurality of projections 292 provided on the belt transport chains 244. Projections 292 may include studs, bolts or other attachment devices as would be known to one skilled in the art. The projections 292 extend through attachment holes 280 provided in the outboard portions 276 of the filter belt 214, particularly in the region beyond the perforated support plate 216 and are therefore isolated from and do not affect the filtration functionality of the filter belt 214. When the projections 292 are stud, the studs may be provided with a hole therethrough to receive a cotter pin 306, which provides a convenient means of removably securing the filter belt 214 to the transport chains 244. In some embodiments, at least certain portions of the belt transport chains ride on the “T” shaped track or guide 308 supported on the bottom wall 232 of the filter apparatus 212.

Advantageously, the addition of projections 292 and attachment holes 280 eliminate the need to provide cleats on the filter belt to drive the filter belt for indexing, thereby providing a more robust design with a greater service life.

Experience has further shown that prior art cleats sewn to the filter belt are problematic due to the manufacturing tolerances of belt suppliers which are known to provide filter belts with cleats that are out of tolerance (not square on the belt or positioned at the proper center line). In the prior art, cleats on the filter belt are configured to engage with the flight bars so that movement of the flight chains and flight bars drive the simultaneous movement of the filter belt. Although this is a workable arrangement, the cleats on the filter belt are known to trap foreign materials such as aluminum chips in machining applications, thereby reducing cleat and filter belt service life. Cleats on filter belts eventually tear from the filter belt, requiring equipment downtime to repair or replace. Advantageously, filter belt systems according to the prevent invention eliminate the drawbacks of filter belt cleats of the prior art, thereby providing a filtering apparatus having an extended filter belt life. As discussed earlier, in the present invention the flight bars float above and do not engage the filter belt, and the filter belt is driven by separate belt transport chains and sprockets.

In at least one embodiment, grommets 278 are secured into the attachment holes 280 to further strengthen the filter belt 214 in the region about the attachment holes 280.

Advantageously, in a preferred embodiment the filter belt 214 includes webbing layers 274 secured to the dirty side 240 of the filter belt 214 along the outboard portions 276 of the filter belt 214 in the region including the grommets 278. The filter belt region is rollably contacted by the roller wheels 272 of the flight chains 254. In this embodiment the attachment holes 280 and grommets 278 extend through both the filter belt 214 and webbing layer 274. The presence of the webbing layer 274 and grommets 278 advantageously improve the ruggedness and service life of the filter belt 214 while advantageously enabling the use of a thinner filter belt 214 to achieve better filtration (through smaller filter belt pore size).

As shown on FIGS. 3A and 3B, a fluid seal member 282 is provided between the outboard portions 276 of the filter belt 214 and the sidewalls 234 and 236 of the filter tank 212. The fluid seal members 282 receive pressurized seal fluid (clean filtered liquid) from a pressurized seal fluid supply source, for example the clean tank 110 (see FIG. 1). The fluid seal members 282 include the “T” shaped member 286. The fluid seal members 282 are provided at opposing outer portions of the filter belt 214. The seal members 282 are provided generally along the bottom wall 232 of the filter tank 212, and particularly in the region over the perforated support member 216. Pressurized seal fluid provides a pressurized fluid purge 310 into the fluid seal member 282 to positively pressurize the seal member 282 relative to the developed head pressure of the unfiltered liquid 262 above the perforated support member 216, thereby minimizing the possibility of the unfiltered liquid 262 bypassing the filter belt 214 and contaminating the filtered liquid 264 in the outlet chamber 238. Additionally, the fluid seal member 282 reduces accumulation of material solid contaminants from the unfiltered liquid 262 onto the belt chain track 290 and the outboard portions of the filter belt 276 where the oversize roller wheels 272 of the flight chains 254 roll on the filter belt 214. The “T” shaped member 286 is secured to the sidewalls 234, 236 of the filter tank 212.

In certain embodiments, the perforated support member 216 is a metal plate having perforations or holes punched therethrough. In other embodiments, the perforated support member is a welded wire mesh having opening therethrough.

While the best modes for carrying out the invention have been described in detail, those familiar with the art to which this invention relates will recognize various alternative designs and embodiments for practicing the invention within the scope of the appended claims.

1. A filter apparatus for filtering material solids from a liquid, comprising:
a filter tank having an inlet line for admitting unfiltered liquid;
a filter belt system including:
a filter belt having a filter media and having a belt length configured as a continuous loop, said filter media configured to permit liquid to pass through said filter belt while blocking passage of at least a portion of said material solids, said filter belt having a dirty side and a clean side;
a perforated support member secured to a bottom wall of said filter tank and supportively contacting said clean side of said filter belt;
an outlet chamber for receiving said filtered liquid and having an outlet line, said outlet chamber sealed to said filter tank proximate to a second side of said perforated support member; and
a pair of fluid seal members, each positioned proximate to and having a first portion extending over outboard portions of said filter belt, said fluid seal members secured at a second portion to sidewalls of said filter tank, each fluid seal member further including:
a closure member extending outwards from said fluid seal member into a position proximate to said filter belt, said closure member operable to limit flow through said seal member;
wherein said seal members include a pressurized fluid purge;
wherein said perforated support member together with said filter belt, said fluid seal members and said pressurized fluid purge are configured to maintain separation of said unfiltered liquid in said filter tank and said filtered liquid in said outlet chamber, and
wherein said closure member is operable to limit bypass flow of unfiltered liquid around said filter belt.

2. A filter apparatus for filtering material solids from a liquid, comprising:
a filter tank having an inlet line for admitting unfiltered liquid and an operating liquid level;
a filter belt system including:
a filter belt having a filter media and having a belt length configured as a continuous loop, said filter media configured to permit liquid to pass through said filter belt while blocking passage of at least a portion of said material solids, said filter belt having a dirty side and a clean side;
a discharge chute at one end of said filter tank, said discharge chute elevated above said operating liquid level;
a perforated support member secured to a bottom wall of said filter tank and supportively contacting said clean side of said filter belt;
an outlet chamber for receiving said filtered liquid and having an outlet line, said outlet chamber sealed to said filter tank proximate to a second side of said perforated support member, said filter belt and said perforated support member operative to isolate said unfiltered liquid in said filter tank from said filtered liquid in said outlet chamber;
a flight chain assembly including:
a pair of flight chains, each formed in a continuous loop along a flight chain path and positioned in a spaced parallel relationship;
a plurality of flight bars extending between and secured at opposing ends to said pair of flight chains and positioned in a spaced relationship along said flight chains, said flight bars arranged substantially perpendicular to said flight chain path and perpendicular to the movement of said filter belt, movement of said flight bars acting together with movement of said filter belt to transport said material solids separated from said filtered liquid to said discharge opening; and
a plurality of pairs of flight chain sprockets, sprockets in each flight chain sprocket pair axially spaced apart, said flight chain sprocket pairs positioned about a flight chain path to guide, support and tension said flight chain, wherein at least one of said flight chain sprocket pairs is operable to driveably move said flight chain along said flight chain path;
wherein said flight chains support said flight bars in a position proximate to but not contacting said filter belt.

3. The filter apparatus of claim 2, wherein
said segments of said flight chains include roller wheels having a diameter selected to rollably support said flight chains on said dirty side of said filter belt.

4. A filter apparatus for filtering material solids from a liquid, comprising:
a filter tank having an inlet line for admitting unfiltered liquid and an operating liquid level;
a filter belt system including:
a filter belt having a filter media and having a belt length configured as a continuous loop, said filter media configured to permit liquid to pass through said filter belt while blocking passage of at least a portion of said material solids, said filter belt having a dirty side and a clean side;
a pair of belt transport chains positioned in a spaced parallel relationship proximate to outboard portions of said filter belt, each chain formed of a plurality of hingeably linked segments coupled to form a continuous loop, each belt transport chain following a belt chain path, wherein said filter belt is removably secured to at least a portion of said segments of said belt transport chains; and
a plurality of pairs of belt chain sprockets, sprockets in each pair axially spaced apart to engage said belt chain, said belt chain sprocket pairs positioned about said filter belt path to guide, support and tension said filter belt chains, wherein at least one of said belt chain sprocket pairs is operable to driveably index said belt chain along said belt chain path;
a discharge chute at one end of said filter tank, said discharge chute elevated above said operating liquid level;
a perforated support member secured to a bottom wall of said filter tank and supportively contacting said clean side of said filter belt;
an outlet chamber for receiving said filtered liquid and having an outlet line, said outlet chamber sealed to said filter tank proximate to a second side of said perforated support member;
a pair of fluid seal members, each positioned proximate to and having a first portion extending over a different one of said outboard portions of said filter belt, said fluid seal members secured at a second portion to sidewalls of said filter tank; said first portion spaced apart from said perforated plate and filter belt to further serve as a guide for flight chains, each fluid seal member further including:
a closure member extending outwards from said fluid seal member into a position in proximity to said filter belt, said closure member operable to limit flow through said seal member;
wherein said seal members include a pressurized fluid purge;
wherein said perforated support member together with said filter belt, said fluid seal members and said pressurized fluid purge are configured to maintain separation of said unfiltered liquid in said filter tank from said filtered liquid in said outlet chamber, and
wherein said closure member is operable to limit bypass flow of unfiltered liquid around said filter belt;
a flight chain assembly including:
a pair of flight chains, each formed in a continuous loop along a flight chain path and positioned in a spaced parallel relationship;
a plurality of flight bars extending between and secured at opposing ends to said pair of flight chains and positioned in a spaced relationship along said flight chains, said flight bars arranged substantially perpendicular to said flight chain path and perpendicular to the movement of said filter belt, movement of said flight bars acting together with movement of said filter belt to transport said material solids separated from said filtered liquid; and
a plurality of pairs of flight chain sprockets, sprockets in each flight chain sprocket pair axially spaced apart, said flight chain sprocket pairs positioned about a flight chain path to guide, support and tension said flight chain, wherein at least one of said flight chain sprocket pairs is operable to driveably move said flight chain along said flight chain path;
wherein said flight chains support said flight bars in a position proximate to but not contacting said filter belt.

5. The filter apparatus of claim 4 wherein
said filter belt includes a webbing layer secured to said filter belt at said outboard portion of said filter belt;
wherein said filter belt has a plurality of attachment holes extending through said webbing layer and said filter belt, said filter belt further including:
a plurality of grommets secured to said filter belt at said holes.

6. The filter apparatus of claim 5, wherein
said belt transport chains further include a plurality of threaded protrusions adapted to insert into said grommets for removably securing said filter belt to said belt transport chains.

7. The filter apparatus of claim 5, wherein
said belt transport chains further include a plurality of studs adapted to insert into said grommets, said filter belt grommets removably secured to said studs by cotter pins.

8. The filter apparatus of claim 5, wherein
said flight chain further comprise oversize rollers rotatably secured to segments of said flight chain, said oversize rollers configured to rollably ride upon said webbing and to space apart said flight bars from said filter belt, said roller wheels having a diameter larger than a segment width of said flight chains.

9. The filter apparatus of claim 4 further including
a pair of webbing members secured proximate to opposing outboard portions of said filter belt and extending along said length of said belt;
wherein said webbing members reinforce edge portions of said filter belt;
wherein said grommets extend through said webbing; and
wherein said flight chain includes roller wheels configured to rollably support said flight chain and flight bars on said webbing members.

10. The filter apparatus of claim 9, wherein
said inlet for liquid to be filtered is connected to a source of dirty coolant/lubricant liquid from a machining operation.

11. The filter apparatus of claim 8 further comprising:
a vacuum pump in fluid communication with said outlet line, said vacuum pump operable to increase a pressure differential across said filter belt to increase liquid flow rate therethrough, said vacuum pump configured to shutdown during periods when said filter belt is indexing; and
a clean tank operably connected to an outlet of said pump, said clean tank operable to subsidize fluid flow rate from the filter apparatus during periods when said filter belt is indexing, said clean tank elevated to provide sufficient head pressure to supply said pressurized fluid purge.
